(19) United States
(12) Patent Application Publication
(10) Pub. No.: US 2009/0144162 A1
(43) Pub. Date: Jun. 4, 2009

(54) Transaction Security Method and Apparatus

(75) Inventor: Neil Milne, Aberdeenshire (GB)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Neil Milne, Aberdeenshire (GB)

(21) Appl. No.: 11/947,106

(22) Filed: Nov. 29, 2007

(51) Int. Cl. H04L 9/32; G06Q 40/00; G06Q 20/00

(52) U.S. Cl. 705/17; 705/44; 705/43

(57) ABSTRACT

A method and apparatus for increasing the security of transactions between two parties is disclosed. The method and apparatus employ multiple PINs from which elements are selected for user identification. The transactions may be financial transactions or any other transaction where user identification is required.

### FIELD OF THE INVENTION

This invention relates to a transaction security method and apparatus. More particularly, but not exclusively, the invention relates to a transaction security method and apparatus for selecting elements of a personal identification number (PIN) using variable PIN generation.

### BACKGROUND OF THE INVENTION

The introduction of chip and PIN technology has increased the number of PINs that card holders of credit and debit cards must memorize. A recent survey revealing that approximately two million people have to memorize at least five different PINs. The difficulty in memorising so many PINs results in many card holders forgetting at least one of their PINs at some time. This leads to card holders either changing all, or many, of their PINs to be the same, or writing their PINs down, typically in the wallet where their credit and debit cards are kept. Such use of a single PIN for multiple cards or writing down of PINs is a security risk.

The use of a single PIN allows a criminal who obtains a card holder's cards, or card details, to obtain goods, services or money from all of the obtained cards once the PIN has been determined.

Additionally, in those countries where chip and PIN has not been introduced there still exists the possibility of forgery of a cardholder's signature.

The security implications of writing down PINs, particularly in a wallet, are self-evident.

Current chip and PIN technologies store card holder's details on the card's chip. These details include, inter alia, the card holder's bank details, expiry date of the card and a fixed PIN. Typically, the fixed PIN is an invariate four digit number that can only be changed when the card is used in an automatic teller machine (ATM) or other such hardware.

A security issue arises even with such chip and PIN systems in that once the card holder's invariate PIN is known the card can be used until the card is cancelled.

Of particular concern is the use of a chip in chip and PIN cards. This is because the holding of the PIN data upon the chip makes the system vulnerable to being hacked should a customer lose their card as the thief may be able to extract all pertinent data from the card using a suitably programmed card reader.

It will be appreciated that the term “PIN” as used herein encapsulates both pure numeric, combined alphanumeric and pure alphabetical identifiers, for example an alphabetical password.

### SUMMARY

A method of transaction security may include:

i) storing, on a chip of a payment card, identification data;

ii) selecting part of the identification data for use in a verifying the identity of a user performing a transaction;

iii) requesting the entry of code data at a data entry device of an authorization device;

iv) determining if the code data matches the part of the identification data at the authentication device; and

v) allowing or disallowing continuation of the transaction based upon the determination of step (iv).

The use of only part of identification data for the verification of a user's identity and the use of a coded form of increases transaction security as the sequence of the identification data and its coding key must be known.

The method may include requesting the selection of the part of the identification data, following insertion of a payment card into the authorization device. The authorization device may comprise an ATM or point of sales (POS) terminal. The method may also include carrying out the determination of step (iv) at the authorization device.

The method may further include selecting a two character string as the part of the identification data. The identification data may comprise any one of the following: alphabetical string, an alphanumeric string as well as coding the identification data as a series of numerical values. The method may include assigning each letter of the alphabet a numerical value, for example corresponding to its position in the alphabet. The numerical value may be a two digit decimal number. Such a coding scheme is relatively easy for a user to remember.

The data entry device may include any one of the following: alphanumeric keypad, alphabetic keypad. The keypad may be encrypted. The server may comprise an encryption key to allow the determination of step (iv) to be carried out.

The method may include storing a plurality of identification data associated with a user at the chip, selecting which of the identification data to select a part of in step (ii) and selecting which of the identification data to select a part of in step (ii) based upon any of the following: temporal criteria, geographical criteria. The temporal criteria may include any one of the following: a monthly basis, quarterly basis, any other suitable temporal period. The geographical basis may include any one of the following: different town, different region, different state, different country, any other suitable geographical criteria.

The variation of the identification data selected based upon, for example, temporal or geographical criteria increases transaction security as even if identification data for a particular period or location becomes compromised a new PIN can be selected from the plurality

The method may also include switching between a first and a second of the identification data in response to a user request, following a successful determination at step (iv).

The present disclosure further provides a transaction security apparatus including a transaction authorization device having a processor, a card reader and a data entry device, the authorization device being arranged to request the selection of part of the identification data for use in a verifying the identity of a user performing a transaction, following receipt of a payment card in the card reader, from a chip on the payment card, the authorization device being arranged to request entry of code data via the data entry device, the processor being arranged to compare the code data and the part of the identification data selected for use in verification of the user's identity and to generate allowance data based upon the comparison, the terminal being arranged either allow or prohibit the transaction based upon the contents of the allowance data and the terminal being arranged to output the allowance data to a server of a financial institution.

The authorization device may include an ATM or point of sales (POS) terminal. The processor may be arranged to request a two character string as the part of the identification data. The identification data may include any one of the following: alphabetical string, an alphanumeric string.

The processor may be arranged to code the identification data as a series of numerical values. The processor may be arranged to assign each letter of the alphabet a numerical value, for example corresponding to its position in the alphabet. The numerical value may be a two digit decimal number.

The data entry device may comprise any one of the following: alphanumeric keypad, alphabetic keypad. The keypad may be encrypted. The processor may comprise an encryption key corresponding to that of the keypad. The chip may store a plurality of identification data associated with a user upon the data storage device. The chip may be arranged to select which of the identification data is available for selection of a part of it. The chip may be arranged to select which of the identification data to select a part of based upon any of the following: temporal criteria, geographical criteria. The temporal criteria may comprise any one of the following: a monthly basis, quarterly basis, any other suitable temporal period. The geographical basis may comprise any one of the following: different town, different region, different state, different country, any other suitable geographical criteria. The chip may be arranged to switch between a first and a second of the identification data in response to a user request once the transaction has been allowed.

The present disclosure further provides a payment card including a chip, the chip storing a identification data thereupon, the chip being arranged to select a part of the identification data to be used as verification of a user's identity upon receipt of a request for identification data from an authorization device.

The chip may store a plurality of identification data associated with a user upon the data storage device. The chip may be arranged to select which of the identification data is available for selection of a part of it.

The chip may be arranged to select which of the identification data to select a part of based upon any of the following: temporal criteria, geographical criteria. The temporal criteria may comprise any one of the following: a monthly basis, quarterly basis, any other suitable temporal period. The geographical basis may comprise any one of the following: different town, different region, different state, different country, any other suitable geographical criteria. The chip may be arranged to switch between a first and a second of the identification data in response to a user request once the transaction has been allowed.

The present disclosure may also provide software which, when executed upon a transaction authorization device, causes the authorization device to request the selection of part of identification data stored upon a chip of a payment card inserted into a card reader of the authorization device, request entry of code data via a data entry device of the authorization device, compare the code data to the part of the identification data and determine whether a transaction is allowed or not.

Also disclosed is a method of transaction security that includes:

i) storing, at a server, identification data; ii) selecting part of the identification data for use in a verifying the identity of a user performing a transaction; iii) transferring a request for the identification data to a data entry device across a network; iv) requesting the entry of code data at the data entry device of an authorization device; v) transferring the code data across the network to the server; iv) determining if the code data matches the part of the identification data at the server; and vi) allowing or disallowing continuation of the transaction based upon the determination of step (iv).

The use of only part of identification data for the verification of a user's identity and the use of a coded form of increases transaction security as the sequence of the identification data and its coding key must be known.

The method may include requesting the selection of the part of the identification data, following insertion of a payment card into the authorization device. The authorization device may comprise an ATM or point of sales (POS) terminal. The method may also include selecting a two character string as the part of the identification data. The identification data may comprise any one of the following: alphabetical string, an alphanumeric string.

The method may further include coding the identification data as a series of numerical values. The method may comprise assigning each letter of the alphabet a numerical value, for example corresponding to its position in the alphabet. The numerical value may be a two digit decimal number.

Such a coding scheme is relatively easy for a user to remember, and also ensures the compatibility of the method with current ATMs and EPOS terminals. The data entry device may include any one of the following: alphanumeric keypad, alphabetic keypad. The keypad may be encrypted. The server may comprise an encryption key to allow the determination of step (iv) to be carried out.

The method may include storing a plurality of identification data associated with a user at the server. The method may include selecting which of the identification data to select a part of in step (ii).

The method may include selecting which of the identification data to select a part of in step (ii) based upon any of the following: temporal criteria, geographical criteria. The temporal criteria may include any one of the following: a monthly basis, quarterly basis, any other suitable temporal period. The geographical basis may include any one of the following: different town, different region, different state, different country, any other suitable geographical criteria.

The variation of the identification data selected based upon, for example, temporal or geographical criteria increases transaction security as even if identification data for a particular period or location becomes compromised a new PIN can be selected from the plurality

The method may include switching between a first and a second of the identification data in response to a user request, following a successful determination at step (iv).

The present disclosure also provides a transaction security apparatus including a server storing identification data associated with a user and a transaction authorization device including a processor, a card reader and a data entry device, the server being arranged to select part of a the authorization data for use in verifying a transaction and to pass a request for the part of the authorization data across a network to the authorization device, the authorization device being arranged to request the entry of code data via the data entry device, the authorization device being arranged to pass the code data to the server via the network and the server being arranged to compare the code data and the part of the identification data selected for use in verification of the user's identity and to allow or disallow the transaction based upon the comparison of the code data to the part of the identification data.

The authorization device may include an ATM or point of sales (POS) terminal.

The server may be arranged to request a two character string as the part of the identification data. The identification data may include any one of the following: alphabetical string, an alphanumeric string.

The authorization device may be arranged to code the identification data as a series of numerical values. The authorization device may be arranged to assign each letter of the alphabet a numerical value, for example corresponding to its position in the alphabet. The numerical value may be a two digit decimal number.

The data entry device may include any one of the following: alphanumeric keypad, alphabetic keypad. The keypad may be encrypted. The server may comprise an encryption key corresponding to that of the keypad.

The server may store a plurality of identification data associated with a user upon a data storage device. The server may be arranged to select which of the identification data is available for selection of a part of it.

The server may be arranged to select which of the identification data to select a part of based upon any of the following: temporal criteria, geographical criteria. The temporal criteria may include any one of the following: a monthly basis, quarterly basis, any other suitable temporal period. The geographical basis may comprise any one of the following: different town, different region, different state, different country, any other suitable geographical criteria.

The server may be arranged to switch between a first and a second of the identification data in response to a user request once the transaction has been allowed.

The present disclosure also provides software which, when executed upon a server, causes the server to select part of identification data stored thereupon, transmit a request for said part of the identification data to an authorization device via a network, receive code data from the authorization device, and to compare the code data to the part of the identification data and determine whether a transaction is allowed or not.

### BRIEF DESCRIPTION OF THE DRAWINGS

Embodiments of the invention will now be described, by way of example only, with reference to the accompanying drawings, in which:

FIG. 1 is a schematic diagram of an embodiment of a transaction security apparatus;

FIG. 1a is representation of an embodiment of a keyboard of the apparatus of FIG. 1;

FIG. 1b is representation of an alternative embodiment of a keyboard of the apparatus of FIG. 1;

FIG. 2 is a flow diagram showing the steps of a transaction security method;

FIG. 3 is a schematic diagram of an embodiment of a transaction security apparatus; and

FIG. 4 is a flow diagram showing the steps of a transaction security method.

### DETAILED DESCRIPTION

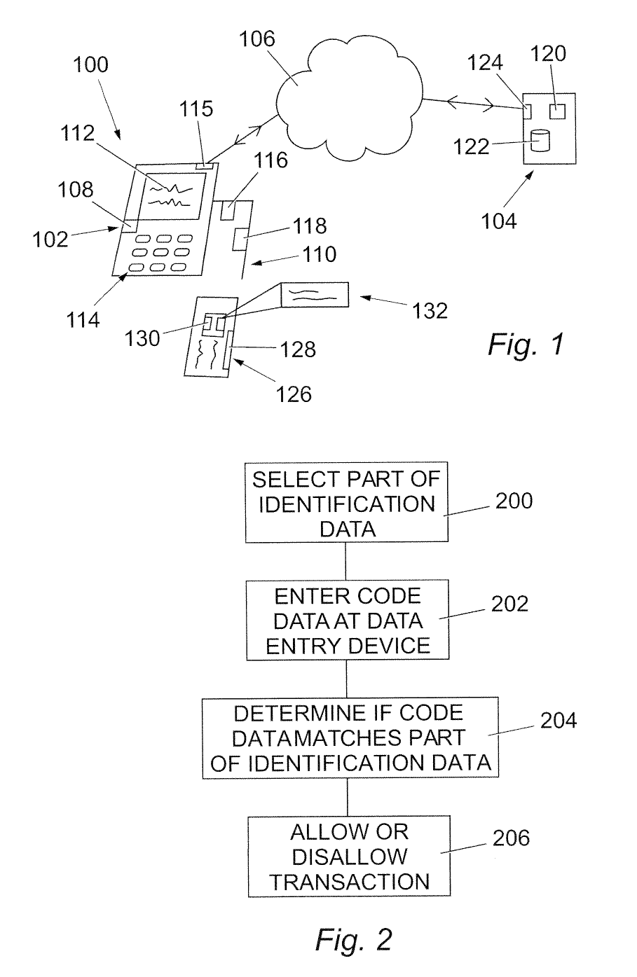

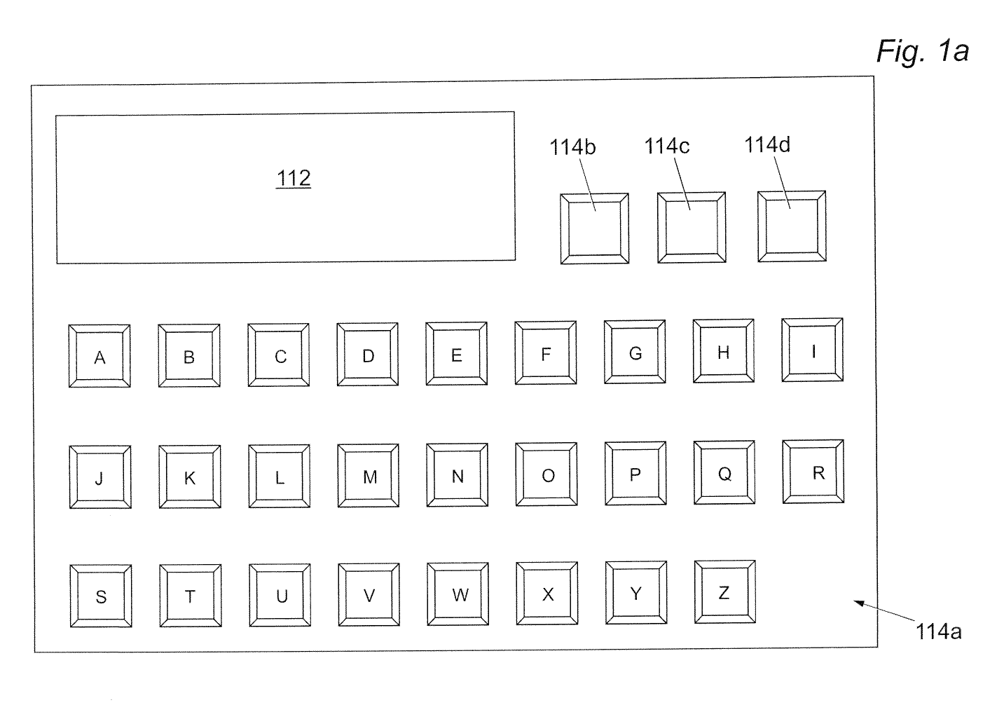

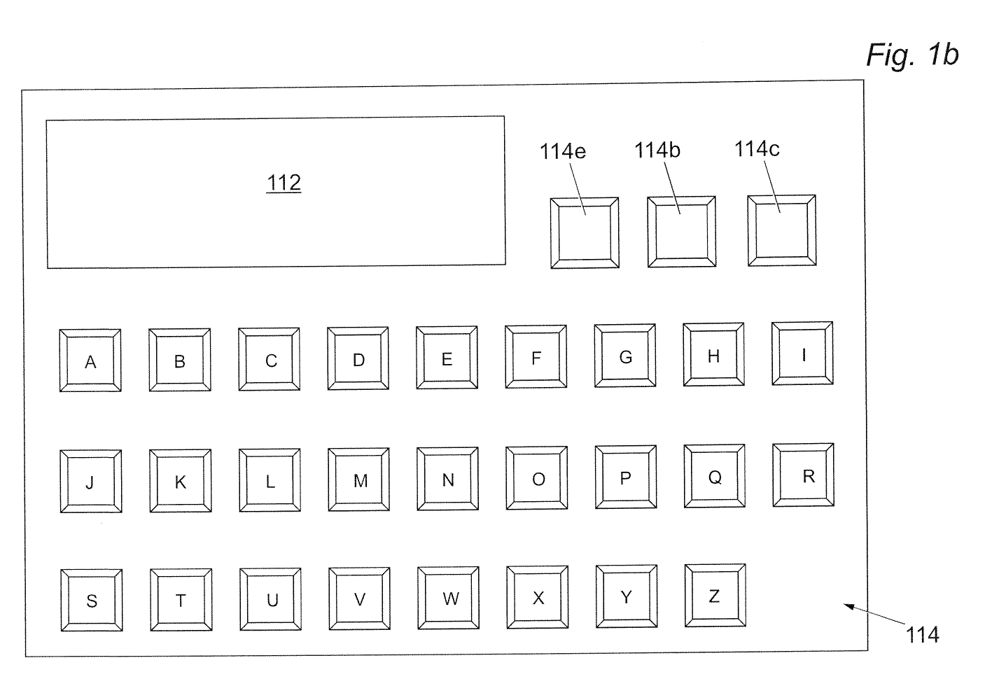

Referring now to FIGS. 1 to 1b, a transaction security apparatus 100 includes a transaction authorization device 102, a server 104 and a network 106. Typically, the transaction authorization device 102 includes an ATM or an electronic point of sale (EPOS) sales terminal, for example as those manufactured by NCR Corporation of Ohio. The server 104 is typically a secure server operated by a bank, or other large financial institution. Typically, the network 106 is a secure private network, or a virtual private network (VPN) established over a public network, for example the Internet.

The authentication device 102 includes a processor 108, card reader 110, a screen 112, a data entry device 114 and a network connection 115. The card reader 110 includes a chip and PIN reader 116 and a magnetic strip reader 118. Typically, the data entry device 114 is an encrypted keyboard as is known to those skilled in the art of ATMs. It will be appreciated that other data entry devices such as microphones can be used.

Referring in particular to FIG. 1a, the data entry device 114 includes a keypad 114a, an enter key 114b, a cancel key 114c and an alert key 114d. Referring in particular to FIG. 1b, the data entry device 114 includes a keypad 114a, an enter key 114b, a cancel key 114c and a change password key 114e. It will be appreciated that in either of the two embodiments of the data entry device 114 shown in FIGS. 1a, and 1b the keypad 114a may be numeric, alphanumeric or alphabetical. It will be appreciated that the data entry device 114 may either, or both of the alert key 114d and the change password key 114e. The server 104 processor 120, a data storage device 122 and a network connection 124.

A payment card 126 magnetic strip 128 and a chip 130. The chip 130 has stored upon it, inter alia, PIN 132. Typically, the PIN 132 an alphabetical string or an alphanumeric string. For example the PIN 132 may be a word that is important to a user for example “HOME” or it may be random selection of characters “F3JZ89”.

A user inserts the payment card 126 into the card reader 110. The processor 108 interrogates the chip 130 for part of the PIN 132. For example, the processor 108 may request the first and third characters of the PIN 132, “HM” and “FJ” in the examples given above.

In one embodiment, the user can use the change password key 114e to select which of their plurality of PINs 132 they would prefer to use, or allow the server 104 to make the choice on their behalf. If a user has, for example, five passwords the change password key 114e can be used to cycle through them by multiple depressions of the key 114e.

The processor 108 outputs a request for these characters to the screen 112. The user enters code data via the data entry device 114. The code data is compared to the part of the PIN 132 and a transaction either forbidden or permitted dependent upon whether the code data and the PIN match.

If the transaction is allowed allowance data is generated at the processor 108 and this is passed across the network 106 to the server 104 of the user's bank, or other financial institution where a debit is made from their account.

In another embodiment, the part of the PIN 132 used in verifying the user's identity is coded, for example by converting each letter into a two digit number. Typically, the two digit number may be the position of the letter in the alphabet. In this embodiment numerical values forming part of the PIN 132 are, typically, left unchanged. For example, in the examples above the letters “HM” correspond to the numerical value “0813”, and “FJ” correspond to the numerical value “0610”. The use of such numerical coding allows the retrofitting of this invention to existing ATMs and EPOS terminals having only numeric keypads.

In a further embodiment, the data entry device 114 may comprise an alphanumeric keypad or keyboard. This allows direct entry of alphanumeric elements of the part of the identification.

In a still further embodiment, the chip 130 stores a plurality of PINs 132. The chip 130 selects which of the PIN 132 to select a part of in response from the authentication device 102.

Alternatively, each of the plurality of PINs 132 may correspond to a set maximum transaction limit. For example, a first PIN 132 “HOME” could be used for individual transactions below ±100 and a second PIN 132 “F3JZ89” used for individual transactions above £100. Additionally, or alternatively, a cumulative transaction limit may be place upon the use of each PIN 132. For example, a cumulative limit of £1,000 in any calendar month, or other pre-determined time period, may be placed upon one of the PINs 132, such as “HOME.” The effect of this cumulative limit being breached would be to request characters from a second password, such as “F3JZ89.” Which ever of the passwords required would be displayed upon the screen 112.

The choice of which of the PINs 132 to use can be based upon, for example, temporal criteria or geographical criteria. For example, the PIN 132 chosen may be “HOME” in alternate months and “F3JZ89” in the intervening months. Alternatively, where a plurality of PINs have been defined the PINs may be cycled through on a monthly, weekly, quarterly or yearly basis. For example where there are PINs one, two and three they could be rotated to be ordered three, one and two and on the subsequent rotation two, three and one.

In relation to geographical criteria, the user may have a different PIN 132, or set of PINs, that is activated when a bank receives a request from an overseas ATM or EPOS terminal. This means that a card cloned overseas cannot be used reliably in the user's home country.

In a preferred embodiment, should a user feel uneasy about a request from a vendor they can use the alert key 114d to notify their financial institution of this. Examples of when this may be used include, if the vendor requested additional information about an already entered PIN or claimed that a transaction had not been processed following entry of the PIN 132. The use of the alert key 114d would trigger a request for characters from a special ‘safe’ PIN in the manner described hereinbefore in relation to standard PINs. The transaction would not be completed unless these letters were entered correctly by the user.

In a still further embodiment, the chip 130 allows a user to switch between PINs in response to a user request once the transaction has been allowed so as to maintain control over their PIN usage and prevent the reuse of a PIN that they have previously used.

The blocking of payment cards in response to unusual payment patterns is well established and is inconvenient for legitimate users of the blocked cards. However, the present invention allow this to be overcome by force changing the requested PIN 132 from the server 104 of the financial institution if a particular PIN 132 has been used to verify a pre-determined number of transactions. For example, if the PIN 132 “HOME” has been used for fifty consecutive transactions the server 104 may force the card reader to request characters from the alternative PIN 132 “F3JZ89”.

Referring now to FIG. 2 of the drawings, a method of transaction storing, on a chip of a payment card, a PIN or multiple PINs associated with a user. Part of the PIN is selected for use in a verifying the identity of a user performing a transaction (Step 200). Code data is entered at a data entry device of an authorization device (Step 202). A determination is made if the code data matches the part of the PIN at the authentication device. (Step 204) The transaction is either allowed or disallowed based upon whether the code data and part of the PIN match (Step 206).

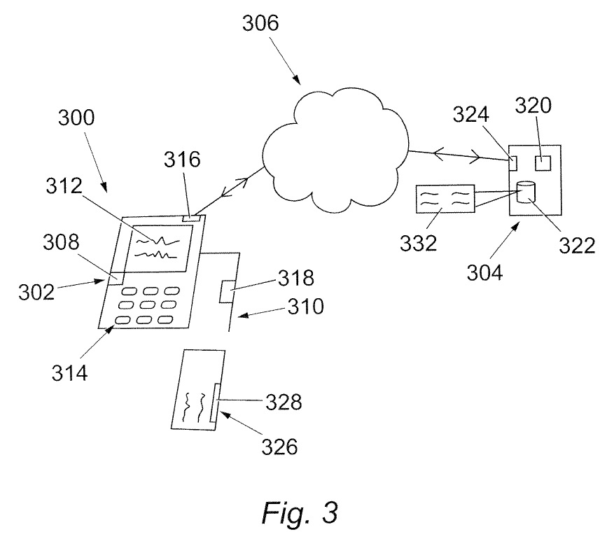

Referring now to FIG. 3, an alternative embodiment of a transaction security apparatus 300 comprises a transaction device 302, a server 304 and a network 306. Typically, the transaction device 302 an ATM or an electronic point of sale (EPOS) sales terminal. The server 304 is typically a secure server operated by a bank, or other large financial institution. Typically, the network 306 is a secure private network, or a virtual private network (VPN) established over a public network, for example the Internet.

The transaction device 302 a processor 308, card reader 310, a screen 312, a data entry device 314 and a network connection 316. The card reader 310 magnetic strip reader 318. Typically, the data entry device 314 is an encrypted keyboard as is known to those skilled in the art of ATMs.

The server 304, a processor 320, a data storage device 322 and a network connection 324. The data storage device 322 stores customers' account details and also their PINs. Each customer may have more than one PIN. For example the PIN 332 may be a word that is important to a user for example “HOME” or it may be random selection of characters “F3JZ89”.

A payment card 326 comprises a magnetic strip 328. A user inserts the payment card 326 into the card reader 310. The processor 308 interrogates the magnetic strip 328 such that the user's bank account can be identified. The processor 308 contacts the server 304 via the network 306 and requests part of a PIN 332 associated with the account identified from the magnetic strip 328. The PIN is stored on the data storage device 322. For example, the server 304 transfers a request for the first and third characters of the PIN 332, to the transaction device 302. The PIN 332 resides at the server 304 and data corresponding to the elements of the PIN 332 are not transferred via the network 306.

The processor 308 outputs a request for these characters to the screen 312. The user enters code data via the data entry device 314. The methods of data entry available for this embodiment of the invention are substantially the same as those for the first embodiment of the invention, i.e. alphanumeric keypad or a numeric coding of alphabet letters.

The code data entered at the data entry device is transferred across the network 306 to the server 304. The server's processor 320 compares the code data to the requested part of the PIN 332, and a transaction is either forbidden or permitted dependent upon whether the code data and the PIN match.

If the transaction is allowed a debit is made from the user's account and confirmation data is passed across the network 306 to the transaction device 302.

The features of PIN management, for example the use and rotation of PINs, and enhanced transaction security described in relation to FIGS. 1 to 2 apply equally to the embodiment of FIG. 3 but at a server level rather than via a chip on a payment card.

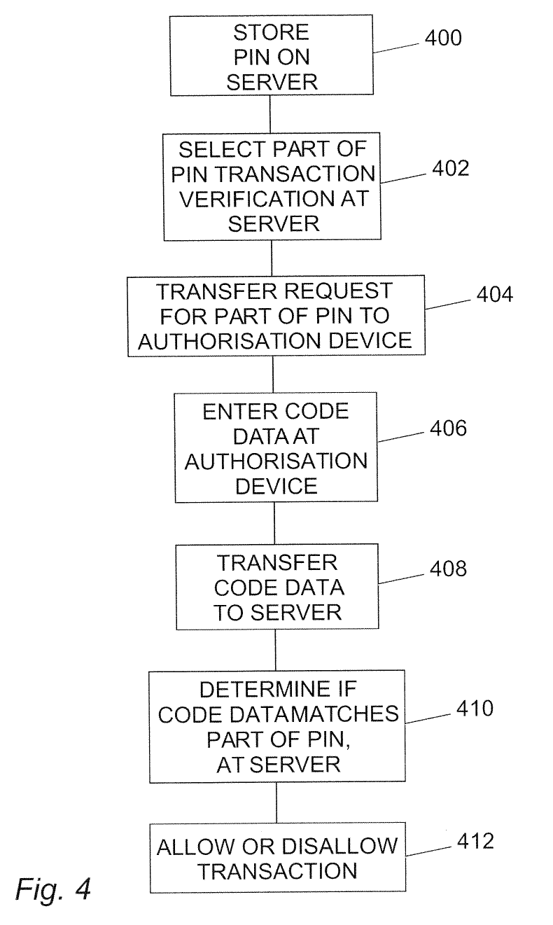

Referring now to FIG. 4, a method of transaction security comprises storing, on a server, a PIN or multiple PINs associated with a user (Step 400). Part of the PIN is selected for use in a verifying the identity of a user performing a transaction (Step 402). A request for this part of the PIN is transferred across a network to a data entry device (Step 404). Code data is entered at a data entry device of an authorization device (Step 406). The code data is transferred from the data entry device to the server via the network (Step 408). A determination is made if the code data matches the part of the PIN at the server (Step 410). The transaction is either allowed or disallowed based upon whether the code data and part of the PIN match (Step 412).

It will be appreciated that non-mutually exclusive elements of the various embodiments may be freely interchanged and combined.

It will be appreciated that the disclosed invention is not limited to use with ATMs and EPOS terminals but may be readily incorporated into software for Internet transaction security, for example Internet banking.

It will be further appreciated that the use of passwords in conjunction with swipe cards is not limited to financial transactions but can be used in such areas as border controls and identity cards. It is envisaged that in such an identification system a user will input certain details with a government agency, for example height, weight and sex. When stopped by a law enforcement, or border, control officer an identity card will be swiped and the person asked to verify their identity by means of a password as described hereinbefore. The correct entry of a password, in conjunction with the user matching the previously entered physical criteria will be sufficient to identify the user as who they claim to be to the officer.

Various modifications and variations to the described embodiments of the inventions will be apparent to those skilled in the art without departing from the scope of the invention. Although the invention has been described in connection with specific preferred embodiments, it should be understood that the invention as claimed should not be unduly limited to such specific embodiments.

We claim:

1. A method of transaction security comprising:
i) storing, on a chip of a payment card, identification data;
ii) selecting part of the identification data for use in a verifying the identity of a user performing a transaction;
iii) requesting the entry of code data at a data entry device of an authorization device;
iv) determining if the code data matches the part of the identification data; and
v) allowing or disallowing continuation of the transaction based upon the determination of step (iv).

2. The method of claim 1 comprising requesting the selection of the part of the identification data, following insertion of a payment card into the authorization device.

3. The method of claim 1, wherein the authorization device comprises an ATM or point of sales (POS) terminal.

4. The method of claim 1 comprising carrying out the determination of step (iv) at the authorization device.

5. The method of claim 1 comprising selecting a two character string as the part of the identification data.

6. The method of claim 1 storing a plurality of identification data associated with a user upon the chip of a payment card.

7. The method of claim 6 comprising selecting which of the identification data to select a part of in step (ii).

8. A transaction security apparatus comprising a transaction authorization device comprising a processor, a card reader and a data entry device, the terminal being arranged to request the selection of part of the identification data for use in a verifying the identity of a user performing a transaction, following receipt of a payment card in the card reader, from a chip on the payment card, authorization device being arranged to request entry of code data via the data entry device, the processor being arranged to compare the code data and the part of the identification data selected for use in verification of the user's identity and to generate allowance data based upon the comparison, the terminal being arranged either allow or prohibit the transaction based upon the contents of the allowance data and the terminal being arranged to output the allowance data to a server of a financial institution.

9. The apparatus of claim 8, wherein the authorization device comprises an ATM or point of sales (POS) terminal.

10. The apparatus of claim 8, wherein the processor is arranged to request a two character string as the part of the identification data, and wherein the character string may be alphanumeric or alphabetical.

11. The apparatus of claim 8, wherein the chip stores a plurality of identification data.

12. The apparatus of claim 8 comprising an alert key.

13. A payment card comprising a chip, the chip storing an identification data thereupon, the chip being arranged to select a part of the identification data to be used as verification of a user's identity upon receipt of a request for identification data from an authorization device.

14. The payment card of claim 13 wherein the chip is arranged to store a plurality of identification data.

15. A method of transaction security comprising the steps of:
i) storing, at a server, identification data;
ii) selecting part of the identification data for use in a verifying the identity of a user performing a transaction;
iii) transferring a request for the identification data to a data entry device across a network;
iv) requesting the entry of code data at the data entry device of an authorization device;
v) transferring the code data across the network to the server
vi) determining if the code data matches the part of the identification data at the server; and
vii) allowing or disallowing continuation of the transaction based upon the determination of step (vi).

16. The method of claim 15 comprising storing a plurality of identification data associated with a user at the server.

17. The method of claim 16 comprising allowing user selection of which of the plurality of identification data to select part of in step (ii).

18. The method of claim 16 comprising switching between a first and a second of the identification data in response to a user request, following a successful determination at step (vi).

19. A transaction security apparatus comprising a server storing identification data associated with a user and a transaction authorization device comprising a processor, a card reader and a data entry device, the server being arranged to select part of authorization data for use in verifying a transaction and to pass a request for the part of the authorization data across a network to the authorization device, the authorization device being arranged to request the entry of code data via the data entry device, the authorization device being arranged to pass the code data to the server via the network and the server being arranged to compare the code data and the part of the identification data selected for use in verification of the user's identity and to allow or disallow the transaction based upon the comparison of the code data to the part of the identification data.

20. The apparatus of claim 19 wherein the server is arranged to request a two character string as the part of the identification data, and wherein the character string may be alphanumeric or alphabetical.

21. The apparatus of claim 19 wherein the server is arranged to code the identification data as a series of numerical values.

22. The apparatus of claim 19 wherein the server stores a plurality of identification data associated with a user upon a data storage device.

23. The apparatus of claim 22 wherein the server is arranged to select which of the identification data is available for selection of a part of it.

24. The apparatus of claim 19 wherein the server is arranged to select which of the identification data to select a part of based upon any of the following: temporal criteria, geographical criteria.

25. The apparatus of claim 19 comprising a user operable mechanism arranged to allow selection of a piece identification data for use from a plurality of identification data stored at the server.
